(19) United States
(12) Patent Application Publication
(10) Pub. No.: US 2017/0244121 A1
(43) Pub. Date: Aug. 24, 2017

(54) FUEL CELL POWERED PORTABLE ELECTRONIC DEVICES

(71) Applicant: Intelligent Energy Limited, Loughborough (GB)

(72) Inventor: Zachary Elliott, Loughborough (GB)

(73) Assignee: Intelligent Energy Limited, Loughborough (GB)

(21) Appl. No.: 15/518,740

(22) PCT Filed: Sep. 30, 2015
(86) PCT No.: PCT/GB2015/052855

§ 371 Date: Apr. 12, 2017

(30) Foreign Application Priority Data
Oct. 14, 2014 (GB) 1418187.9

(51) Int. Cl. H01M 8/04082; G06F 1/16; H01M 8/2475

(52) U.S. Cl. CPC H01M 8/04208; H01M 8/04216; H01M 8/2475; G06F 1/163; G06F 1/1635; H01M 2250/30

(57) ABSTRACT

A wrist-mountable portable electronic device comprises an electronic device which is incorporated into a housing and a strap, coupled to the housing and configured to retain the wrist-mountable portable electronic device on the wrist of a user. The strap incorporates at least one fuel cell coupled to provide power to the portable electronic device. The portable electronic device may be a watch or a personal communication device or a personal health and/or activity monitor. The strap may further include an integral fuel source coupled to the at least one fuel cell, and the fuel source may be a replaceable cartridge. High power devices to be worn on the wrist may therefore be powered for extended periods of time.

The present invention relates to powering portable electronic devices using fuel cells, and in particular to techniques for the integration of fuel cells into such portable electronic devices.

Portable electronic devices are in widespread use, particularly in the form of notebook or laptop computers, palm-top computers, personal digital assistants, tablet computers, smart phones etc. These devices are generally powered by a rechargeable battery when mains power is not available. The increasing processing power, display resolution, and communication channel capability of such devices leads to an increasing power demand which leads to a significant reduction in the usage time from a single charge of the battery. Consumer demand is generally for greater battery capacity to enable longer periods of use of the portable electronic device without recourse to mains power.

Electrochemical fuel cells are an alternative and/or an additional source of electrical power for many electronic devices, particularly in view of their ability to provide electrical energy from fuel sources having a potentially higher energy density than many battery technologies. However, fuel cells generally have particular physical configurations and support infrastructure requirements that can make it difficult to integrate such fuel cells into some portable devices. Fuel cells are generally arranged in a stack configuration in which multiple fuel cells are disposed in a layered structure allowing them to be electrically connected in series. This makes for a relatively bulky format not ideally suited for integration into some consumer electronic devices. Such layered structures also tend to result in a rigid cuboid structure which is not optimal for incorporation into devices having a thin profile. Fuel cells also require a support infrastructure for the delivery of fluid fuel and oxidant.

It is an object of the present invention to provide a convenient and efficient way to integrate a fuel cell power supply into portable electronic devices.

According to one aspect, the present invention provides a wrist-mountable portable electronic device comprising:
an electronic device incorporated into a housing;
a strap, coupled to the housing and configured to retain the wrist-mountable portable electronic device on the wrist of a user,
the strap incorporating at least one fuel cell coupled to provide power to the portable electronic device.

The strap may comprise a flexible band incorporating the at least one fuel cell. The wrist-mountable portable electronic device may comprise a watch or a personal communication device. The personal communication device may comprise a cellular telephone. The personal communication device may comprise a transceiver configured for short range wireless communication to a cellular telephone. The wrist-mountable portable electronic device may comprise a personal health and/or activity monitor. The strap may include an integral fuel source coupled to the at least one fuel cell. The integral fuel source may comprise a replaceable cartridge. The integral fuel source may comprise a first reactant in a first compartment and a second reactant in a second compartment, and a delivery mechanism configured to controllably combine the first and second reactants. The wrist-mountable portable electronic device may include a membrane on a face of the housing or strap configured to allow passage of moisture therethrough and a chamber configured to capture moisture passing therethrough.

According to another aspect, the present invention provides a strap for a wrist-mountable portable electronic device, the strap comprising at least one fuel cell capable of providing power to the portable electronic device;
an attachment mechanism for coupling the strap to the wrist-mountable portable electronic device, the attachment mechanism including an electrical pathway for connecting to an external connection of the portable electronic device to enable transfer of electrical power from the at least one fuel cell to the electronic device.

The strap may comprise a flexible band incorporating the at least one fuel cell. The strap may include an integral fuel source coupled to the at least one fuel cell. The integral fuel source may comprise a replaceable cartridge. The integral fuel source may comprise a first reactant in a first compartment and a second reactant in a second compartment, and a delivery mechanism configured to controllably combine the first and second reactants. The strap may include a membrane on a face of the strap configured to allow passage of moisture therethrough and a chamber configured to capture moisture passing therethrough.

Embodiments of the invention will now be described by way of example and with reference to the accompanying drawings in which:

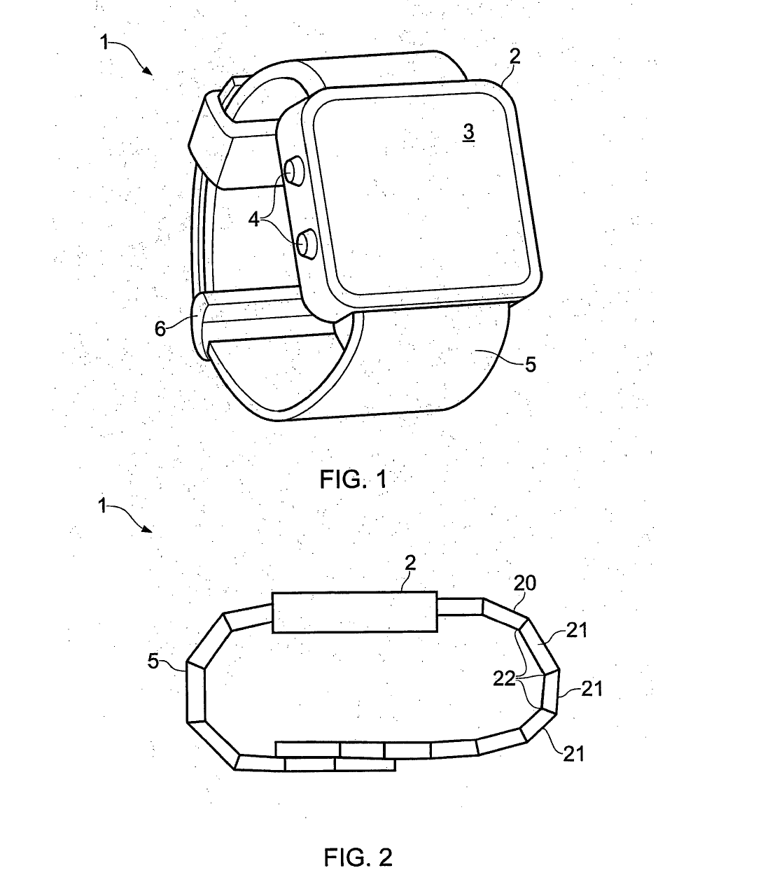

FIG. 1 shows a perspective view of a watch having a fuel cell array incorporated into the wrist strap of the watch;

FIG. 2 shows a schematic side view of a watch similar to FIG. 1;

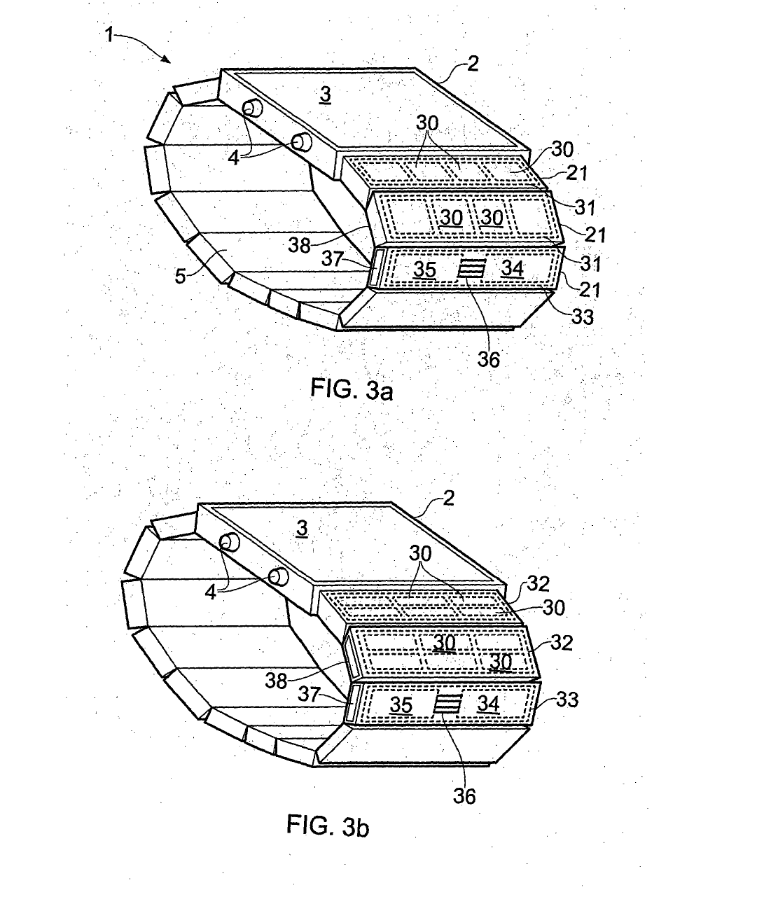

FIG. 3 shows schematic perspective views of the watch of FIG. 1 illustrating positioning of fuel cells in the strap;

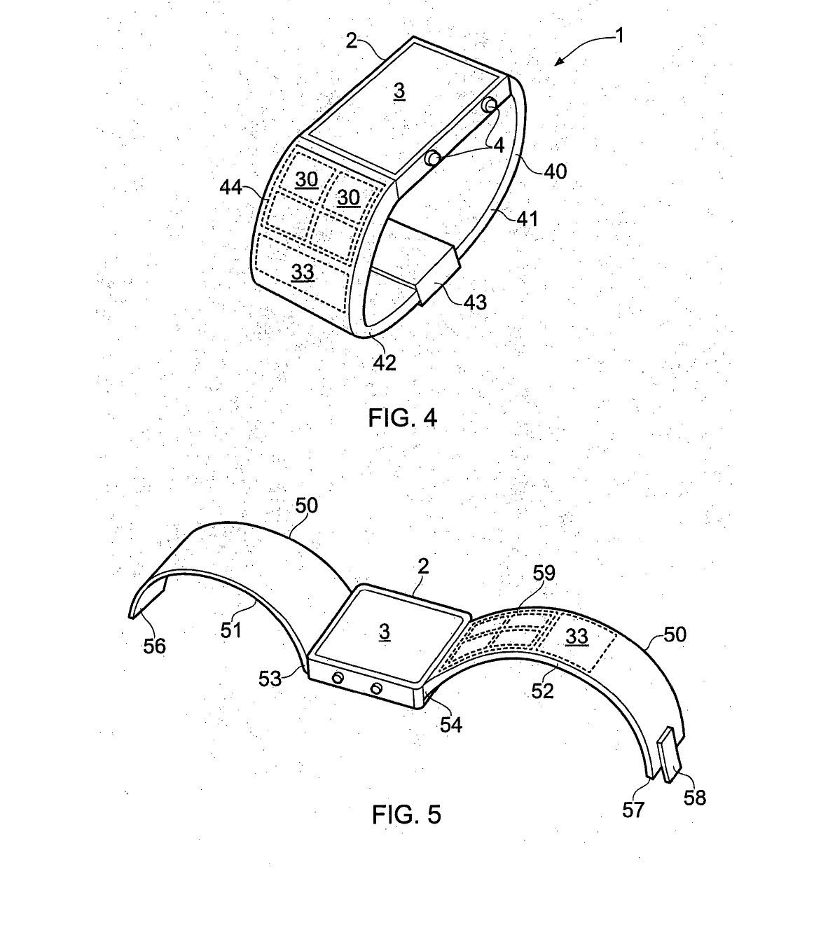

FIG. 4 shows a perspective view of an alternative watch having a fuel cell array incorporated into the wrist strap;

FIG. 5 shows a perspective view of an alternative watch having a fuel cell array incorporated into a wrist strap.

Electrically powered wrist watches have hitherto generally been very low power devices capable of running for extended periods of time (e.g. years) on a single conventional button cell using, for example, lithium ion or silver oxide chemistries. More recently, there has been a significant trend towards providing substantially increased functionality on wrist watches and other wrist-mounted electronic devices.

Functionality that may be provided on a wrist-mountable electronic device may include: GPS receivers for location sensing; Bluetooth or other short range communication transceivers capable of transferring data to and from one or more paired devices such as a mobile telephone or personal computer/tablet computer or home base station; sensors for detecting activity of the user; sensors for detecting health or physical condition of the user; large and/or high resolution displays capable of displaying substantially more information than just time and date; advanced microprocessors capable of processing information relating to GPS tracking, internet connectivity, short range wireless communication connectivity, health and activity sensed data, etc.

Such advanced functionality may not readily or cost-effectively be provided in a satisfactory manner by conventional disposable battery cells. Furthermore, using rechargeable cells alone would impose a burden or inconvenience of frequent recharging which would be unacceptable to many users, particularly if the rechargeable cells were unable to provide sufficient power for one day's use.

Electrochemical fuel cells in combination with a suitable hydrogen fuel source offer a significantly improved energy storage capacity, i.e. a much greater energy density. For example, aluminium hydride as a hydrogen source to deliver hydrogen to an electrochemical fuel cell can offer of the order of 2000 W-hours per litre, thus a volume of only 750 microlitres may be sufficient to provide energy to a high performance wrist-mountable electronic device for a day. A convenient location for an electrochemical fuel cell and a fuel source for powering that fuel cell, on a wrist-mountable electronic device, is the strap which is configured to retain the wrist-mountable portable electronic device on the wrist of a user. This can be achieved with both flexible and inflexible wrist strap configurations as will be discussed below.

With reference to FIG. 1, there is shown a portable electronic device 1 comprising a housing 2 which contains various electronic components (not shown in FIG. 1), a display panel 3, control buttons 4, and a strap 5 with a buckle 6. The display panel 3 may be a touchscreen.

The strap 5 incorporates a fuel cell and a fuel source. The strap 5 may comprise any suitable material and construction which is capable of retaining the portable electronic device on the wrist of a user, and which is capable of housing or providing a supporting substrate for a fuel cell and/or a fuel source. As shown in FIG. 2, the strap 20 may comprise a flexible polymeric or other material comprising a series of relatively stiff segments 21 each coupled to an adjacent segment 21 by a more flexible hinge portion 22. The hinge portion 22 may comprise a thinner section of the same material as for the stiff segments 21 or may be a different material or a hinge to enable limited relative rotation of adjacent segments 21.

Alternatively, the strap 5 may comprise a series of linked rigid segments 21 such as metal segments each capable of limited rotation relative to an adjacent segment 21, with an openable clasp at a midpoint of the strap, in the manner of a watch bracelet. Alternatively, the strap 5 may comprise a series of linked rigid segments such as metal segments each coupled to an adjacent segment by an expanding link, in the manner of an expanding watch bracelet. Alternatively, the strap may comprise continuous bands of flexible material extending between the housing 3 and a clasp.

With reference to FIG. 3, some segments 21 may include one or more fuel cells 30, shown in dashed outline. The fuel cells 30 may form a substantially planar array 31, also shown in dashed outline, with the individual fuel cells 30 forming a one-dimensional array 31 (e.g. a single row) of fuel cells as seen in FIG. 3a. In another arrangement, the fuel cells 30 may form a planar array 32 with the individual fuel cells 30 forming a two-dimensional array 32 (e.g. in rows and columns) of fuel cells as seen in FIG. 3b. Either of the arrangements of FIGS. 3a and 3b could be adapted so that the fuel cells 30 could be stacked face-to-face to form a two- or three-dimensional array 31, 32, i.e. with layers of fuel cells extending through the thickness of the strap.

Each array 31, 32 may occupy a respective strap segment 21. Within each array 31, 32, the fuel cells may be electrically connected in series or in parallel or a combination of both. Arrays 31, 32 may occupy multiple segments 21 of the strap 20. The cells 30 and the arrays 31, 32 may generally be electrically connected in series according to the voltage requirements and/or in parallel according to load requirements. In some planar fuel cell arrays, individual cells can be switched between series and parallel connection, such as described in UK patent application GB 1413781.4.

One or more other segments 21 in the strap 5 may incorporate a fuel source 33 capable of delivering fluid fuel to the fuel cell arrays 31, 32. The fuel sources 33, also shown in dashed outline, may comprise one or more small reaction chambers 34 containing one or more reactant compounds capable of being activated to release fluid fuel which can be fed to the fuel cell arrays 31, 32. Examples of suitable reactant compounds include metal hydrides such as aluminium hydride or sodium borohydride etc, where the activation fluid may be water. The fuel sources 33 may comprise micro-reservoirs 35 of the activation fluid, e.g. water. The activation fluid may be provided in small rupturable blisters which can be mechanically or electrically actuated to release small controlled quantities of the activation fluid into the reaction chambers containing the reactant compounds, via conduits 36.

The fuel sources 33 may be configured as micro-cartridges 37 which can be inserted into a receptacle within the strap segment 21, e.g. via an aperture in one edge 38 of the strap 5. Activation of the fuel sources 33 could be effected by the action of inserting the micro-cartridge 37 into the strap segment 21.

Alternatively, the fuel sources 33 may be integrally formed with the strap 20, and the strap 20 may be disposable once the fuel sources 33 therein are exhausted.

Thus, in a general aspect, the strap 5, 20 of the wrist-mountable portable electronic device 1 may have an integral fuel source 33 comprising a first reactant in a first compartment 34 and a second reactant in a second compartment 35, and a delivery mechanism configured to controllably combine the first and second reactants. The delivery mechanism may include the conduits 36 and any mechanism configured to pump or otherwise pressurise/release one reactant from its compartment to mix with the other reactant in its compartment or in a separate reaction chamber.

More generally, the fuel source may comprise any source capable of producing fluid fuel (e.g. hydrogen) by way of, for example, a hydrolysis reaction; a thermolysis reaction; a desorption process.

With reference to FIG. 4, in an alternative arrangement the strap 40 may be configured as two lengths of flexible material 41, 42 connectable by a buckle or clasp 43. One or both sections 41, 42 of the strap 40 may include a flexible fuel cell or fuel cell array 44 of individual fuel cells 30 extending along the length of the strap 40 or a part thereof. Flexible fuel cells and fuel cell arrays 44 can be formed using thin flexible laminates for each of: an anode flow plate; an anode gas diffusion layer; a membrane-electrode assembly, a cathode diffusion layer; and a cathode flow plate, all of which make up a conventional proton exchange membrane fuel cell. The cathode and anode flow plates may comprise slotted or ridged copper-coated polyimide (e.g. Kapton) film, where the slots or ridges may respectively define the cathode fluid flow channels and the anode fluid flow channels. For both the anode and the cathode, an end plate of the fuel cell may therefore comprise a flexible dielectric film on which is coated the anode or cathode electrode in the form of an electrically conductive coating. The fuel cell may be held together by bonding the polyimide films together at the peripheral edge of the fuel cell. The various layers as described may be integrated into the strap 40, which may itself be formed as a laminated structure, and the layers of the fuel cell may be designed to flex with the strap material. Fluid fuel and oxidant flow paths to the anodes and cathodes may also be integrated into the strap 40 to deliver fuel and oxidant to the fuel cells and fuel cell arrays. Electrically conductive paths may also be integrated into the strap 5 to provide electrical connections to the electronic device in the housing 2.

Similar to the arrangement described in connection with FIG. 3, the strap 40 may also incorporate one or more fuel sources 33 capable of delivering fluid fuel to the fuel cell arrays 44.

With reference to FIG. 5, in an alternative arrangement, the strap 50 may be configured as two rigid or semi-rigid sections 51, 52 each forming a partial circumferential section which is hinged to the wrist-mountable electronic device 55 at hinges 53, 54. The distal ends 56, 57 may be provided with a suitable locking or engagement mechanism such as a clasp 58 for holding the sections 51, 52 around a user's wrist. In this arrangement, the fuel cell or fuel cell array 59 may be a rigid structure formed in a curved configuration to conform to the strap sections 51, 52. In a still further arrangement, the strap may comprise a single rigid or semi-rigid band which extends in one piece from either side of the electronic device 55, in the form of a bracelet which can be slipped on over the hand.

Similar to the arrangement described in connection with FIG. 3, the strap 50 may also incorporate one or more fuel sources 33 capable of delivering fluid fuel to the fuel cell arrays 44.

Although the illustrated embodiments of FIGS. 1 to 5 comprise an electronic device in the form of a watch, the electronic device can be any type of portable electronic device including one, some, or all of the following features: a short range communication device (e.g. Bluetooth enabled) for interfacing with a user's smart phone, computer, tablet or other data processing device which may be disposed nearly; a short range communication device (e.g. wi-fi enabled) device for communicating with the Internet or wireless base station; a cellular telephone device; a GPS receiver for location sensing; an activity monitor incorporating sensors such as accelerometers for detecting activity of the user; a health monitor including sensors for detecting the physical condition of the user, or for communicating with and collecting data from sensors disposed elsewhere on or in the user's body; a display device; a microprocessor capable of processing information relating to GPS tracking, Internet connectivity, short range wireless communication connectivity, health and activity sensed data, etc. More generally, the electronic device may be a personal communication device or a personal health and/or activity monitor.

If a fuel source 33 in the strap of the electronic device 1 incorporates one or more reactant compounds capable of being activated by water to release fluid fuel which can be fed to the fuel cell arrays 31, 44, 59, the water may be provided in part by the water in a cathode exhaust of the fuel cells. Thus the water supply may be self-sustaining once the hydrogen production has started and the fuel cell is in operation. An additional supply of water could be extracted from the user by way of a suitable water-permeable membrane disposed on an inside face of the strap to allow passage of body moisture therethrough when the device is being worn by a user. Thus, in a general aspect, the device may comprise a membrane on a face of the housing or strap configured to allow passage of moisture therethrough and a chamber configured to capture moisture passing therethrough.

Each of the straps discussed above may include an attachment mechanism for releasably coupling the strap to the wrist-mountable portable electronic device so that the strap can be readily replaced, for example if it contains a disposable fuel supply. Each of the straps discussed above may include an attachment mechanism for coupling the strap to the wrist-mountable portable electronic device which includes an electrical pathway for connecting to an external connection of the portable electronic device to enable transfer of electrical power from the fuel cell/fuel cells or fuel cell array/arrays to the electronic device.

The electrical pathway may also include a data communication channel for transfer of data between a processor in the wrist-mountable electronic device and the fuel cell/fuel cell array and/or the fuel source so as to enable control of the fuel cell and/or fuel source and/or the collection of data therefrom, e.g. for control and/or monitoring purposes.

Other embodiments are intentionally within the scope of the accompanying claims.

1. A wrist-mountable portable electronic device comprising:
an electronic device incorporated into a housing;
a strap, coupled to the housing and configured to retain the wrist-mountable portable electronic device on the wrist of a user,
the strap incorporating at least one fuel cell coupled to provide power to the portable electronic device.

2. The wrist-mountable portable electronic device of claim 1 in which the strap comprises a flexible band incorporating the at least one fuel cell.

3. The wrist-mountable portable electronic device of claim 1 comprising a watch.

4. The wrist-mountable portable electronic device of claim 1 comprising a personal communication device.

5. The wrist-mountable portable electronic device of claim 4 in which the personal communication device comprises a cellular telephone.

6. The wrist-mountable portable electronic device of claim 4 in which the personal communication device comprises a transceiver configured for short range wireless communication to a cellular telephone.

7. The wrist-mountable portable electronic device of claim 1 comprising a personal health and/or activity monitor.

8. The wrist-mountable portable electronic device of claim 1 in which the strap further includes an integral fuel source coupled to the at least one fuel cell.

9. The wrist-mountable portable electronic device of claim 8 in which the integral fuel source comprises a replaceable cartridge.

10. The wrist-mountable portable electronic device of claim 8 in which the integral fuel source comprises a first reactant in a first compartment and a second reactant in a second compartment, and a delivery mechanism configured to controllably combine the first and second reactants.

11. The wrist-mountable portable electronic device of claim 1 further including a membrane on a face of the housing or strap configured to allow passage of moisture therethrough and a chamber configured to capture moisture passing therethrough.

12. A strap for a wrist-mountable portable electronic device, the strap comprising at least one fuel cell capable of providing power to the portable electronic device;
an attachment mechanism for coupling the strap to the wrist-mountable portable electronic device, the attachment mechanism including an electrical pathway for connecting to an external connection of the portable electronic device to enable transfer of electrical power from the at least one fuel cell to the electronic device.

13. The strap of claim 12 further comprising a flexible band incorporating the at least one fuel cell.

14. The strap of claim 12 further including an integral fuel source coupled to the at least one fuel cell.

15. The strap of claim 14 wherein the integral fuel source is at least a replaceable cartridge.

16. The strap of claim 14 wherein the integral fuel source further comprises a first reactant in a first compartment and a second reactant in a second compartment, and a delivery mechanism configured to controllably combine the first and second reactants.

17. The strap of claim 12 further including a membrane on a face of the strap configured to allow passage of moisture therethrough and a chamber configured to capture moisture passing therethrough.
